(19) United States
(12) Patent Application Publication
(10) Pub. No.: US 2018/0250658 A1
(43) Pub. Date: Sep. 6, 2018

(54) HONEYCOMB CATALYTIC BODY

(71) Applicant: NGK INSULATORS, LTD, Nagoya-City (JP)

(72) Inventors: Shiori NAKAO, Nagoya-City (JP); Shogo HIROSE, Nagoya-City (JP)

(73) Assignee: NGK INSULATORS, LTD, Nagoya-City (JP)

(21) Appl. No.: 15/901,207

(22) Filed: Feb. 21, 2018

(30) Foreign Application Priority Data
Mar. 1, 2017 (JP) 2017-038133

(51) Int. Cl. B01J 23/30; B01D 53/94; B01J 35/04; B01J 35/10; B01J 35/00; B01J 35/02; F01N 3/20; F01N 3/28

(52) U.S. Cl. CPC B01J 23/30; B01D 53/9418; B01J 35/04; B01J 35/1076; B01J 35/0026; B01J 35/023; F01N 2370/02; F01N 3/2828; B01D 2255/20723; B01D 2255/9205; B01D 2255/9202; F01N 2330/06; F01N 2330/30; F01N 3/2066

(57) ABSTRACT

A honeycomb catalytic body including:
a honeycomb structure having porous partition walls, and
a catalyst layer including a vanadium catalyst,
wherein a cell density of the honeycomb structure is in a range of 8 cells to 48 cells per square centimeter,
an amount of the vanadium catalyst to be loaded is in a range of 150 g/L to 400 g/L, and
a catalyst charging ratio represented by Equation (1) mentioned below in a cut face of the honeycomb catalytic body is from 50% to 100%.

the catalyst charging ratio (%)=(the sectional area of the catalyst layer loaded onto the partition wall inner portions)/(the sectional area of the pores before the catalyst is loaded)×100. Equation (1):

“The present application is an application based on JP-2017-038133 filed on Mar. 1, 2017 with Japan Patent Office, the entire contents of which are incorporated herein by reference.”

### BACKGROUND OF THE INVENTION

### Field of the Invention

The present invention relates to a honeycomb catalytic body, and more particularly, it relates to a honeycomb catalytic body onto which a vanadium catalyst is loaded and which is usable in selective catalytic reduction (SCR) of nitrogen oxides (NOₓ).

### Description of the Related Art

Heretofore, exhaust gases emitted from internal combustion engines such as car engines have included toxic substances such as carbon monoxide (CO), hydrocarbons (HC) and nitrogen oxides (NOₓ). Such toxic substances have influences on natural environments, human bodies and the like, and therefore cannot be emitted as they are to the air atmosphere. Consequently, in the case of a gasoline engine, for example, a three-way catalyst is frequently used which is brought into contact with a noble metal catalyst of platinum, rhodium or the like to convert the toxic substances into carbon dioxide (CO₂), water (H₂O) and a nitrogen gas (N₂) which are comparatively non-toxic.

On the other hand, in the case of a diesel engine, an amount of air to fuel is excessively large, and hence it is difficult to use the above three-way catalyst. To eliminate such a problem, a technology of selective catalytic reduction (SCR) is used in which ammonia (NH₃) is used as a reducing agent to convert NOₓ into a nitrogen gas and water. In consequence, it is possible to treat NOₓ in the exhaust gas with a high purifying efficiency.

For example, in the case of disposing the above catalyst in an exhaust system of a car or the like, when the exhaust gas of a fluid flows through a honeycomb catalytic body along a direction from one end face (an inflow side) to the other end face (an emission side), the exhaust gas containing NOₓ disperses to pass through respective cells. At this time, a catalyst loaded onto partition walls comes in contact with the exhaust gas. Especially, the honeycomb catalytic body has a structure in which a plurality of cells are formed, and hence, opportunities for the exhaust gas to come in contact with the catalyst increase, and a contact area with the catalyst can broaden. As a result, it is possible to exert a high purifying performance. It is to be noted that at least one catalyst for use can be selected from various types of metal catalysts consisting of a metal-substituted zeolite, vanadium, vanadia, titania, tungsten oxide, silver and alumina (e.g., see Patent Document 1).

[Patent Document 1] JP-A-2009-154148

### SUMMARY OF THE INVENTION

An exhaust gas emitted from a diesel engine has a temperature region lower than that of an exhaust gas emitted from a gasoline engine. Therefore, a catalyst for use is required to exhibit high catalytic activity at about 300° C. in the low-temperature region. Consequently, in a purifying treatment of the exhaust gas in which such an SCR technology as described above is used, it is necessary to increase an amount of the catalyst to be loaded onto a honeycomb catalytic body. When the amount of the catalyst to be loaded increases, pressure loss heightens, and hence, for the purpose of suppressing the pressure loss, use of a honeycomb structure having a low cell density (hereinafter referred to as “the low cell density structure”) has been studied.

For the purpose of obtaining the high catalytic activity in the low-temperature region, it has been important to increase the amount of the catalyst to be loaded onto the honeycomb structure. However, due to the increase of the amount of the catalyst to be loaded, a catalyst thickness increases, and it has been worried that a defect of “catalyst peel-off”, i.e., the defect that the loaded catalyst peels off especially easily occurs.

Thus, the present invention has been developed in view of the above actual circumstances, a honeycomb structure of a low cell density is used as a catalyst carrier to maintain a high catalytic activity and inhibit increase of pressure loss even when increasing an amount of a catalyst to be loaded, and occurrence of catalyst peel-off is inhibited.

[1] A honeycomb catalytic body including a honeycomb structure having porous partition walls which define a plurality of cells to form through channels for a fluid and in which a plurality of pores are formed, and a catalyst layer including a vanadium catalyst loaded onto partition wall surfaces and/or partition wall inner portions of the partition walls, wherein a cell density of the honeycomb structure is in a range of 8 cells to 48 cells per square centimeter, an amount of the vanadium catalyst to be loaded is in a range of 150 g/L to 400 g/L, and a catalyst filling ratio represented by Equation (1) mentioned below and indicating a ratio of a sectional area of the catalyst layer loaded onto the partition wall inner portions to a sectional area of the pores before the catalyst is loaded, in a cut face of the honeycomb catalytic body is from 50% to 100%.

the catalyst filling ratio (%)=(the sectional area of the catalyst layer loaded onto the partition wall inner portions)/(the sectional area of the pores before the catalyst is loaded)×100 Equation (1):

[2] The honeycomb catalytic body according to the above [1], wherein a catalyst thickness of the catalyst layer from the partition wall surfaces is in a range of 0 μm to 30 μm.

[3] The honeycomb catalytic body according to the above [1] or [2], wherein a porosity of the partition walls of the honeycomb structure is in a range of 35% to 60%.

[4] The honeycomb catalytic body according to any one of the above [1] to [3], wherein an average pore diameter of the partition walls of the honeycomb structure is in a range of 4 μm to 35 μm.

[5] The honeycomb catalytic body according to any one of the above [1] to [4], wherein a partition wall thickness of the partition walls of the honeycomb structure is in a range of 0.14 mm to 0.20 mm.

According to a honeycomb catalytic body of the present invention, a vanadium catalyst is loaded so that an amount of the catalyst to be loaded is from 150 g/L to 400 g/L, onto the honeycomb structure of a low cell density in which the number of cells present per square centimeter is from 8 to 48, to form a catalyst layer, so that the catalyst does not peel off from the partition walls and a high catalytic activity can be maintained.

Additionally, an increase of pressure loss can be prevented by using the honeycomb structure of the low cell density. Particularly, in a cut face of the honeycomb catalytic body, a catalyst filling ratio represented by a ratio of a sectional area of the catalyst layer loaded onto inner portions of the partition walls to a sectional area of pores before the catalyst is loaded is adjusted in a range of 50% to 100%, so that a defect such as catalyst peel-off does not occur and a higher effect of inhibiting the catalyst peel-off is obtainable.

Furthermore, a catalyst thickness of the catalyst layer from partition wall surfaces, a porosity of the partition walls, an average pore diameter of the partition walls and a partition wall thickness of the partition walls are adjusted in prescribed ranges, respectively, so that the above effect is further stably obtainable.

### BRIEF DESCRIPTION OF THE DRAWINGS

FIG. 1 is a perspective view schematically showing an outline constitution of a honeycomb catalytic body of the present invention;

FIG. 2 is a plan view schematically showing one end face of the honeycomb catalytic body; and

FIG. 3 is an enlarged plan view showing an enlarged part of the one end face of the honeycomb catalytic body of FIG. 2.

### DESCRIPTION OF THE PREFERRED EMBODIMENTS

Hereinafter, description will be made as to an embodiment of a honeycomb catalytic body of the present invention. It is to be noted that the present invention is not especially limited to the following embodiment, and a change, a modification, an improvement and the like are addable without departing from the gist of the present invention.

1. Honeycomb Catalytic Body

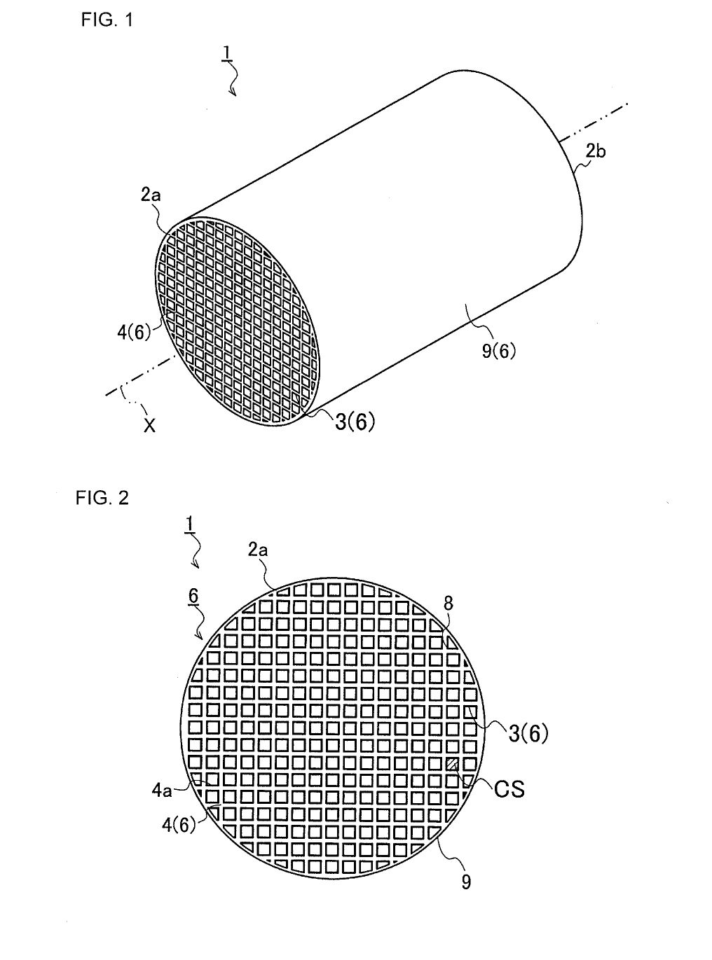

As shown in FIG. 1 to FIG. 3, a honeycomb catalytic body 1 of one embodiment of the present invention possesses a substantially round pillar-shaped appearance. Furthermore, the honeycomb catalytic body includes a honeycomb structure 6 having porous partition walls 4 which define a plurality of polygonal cells 3 extending from one end face 2a to the other end face 2b to form through channels for a fluid and in which a plurality of pores 5 are formed in partition wall surfaces 4a and/or partition wall inner portions 4b, and a catalyst layer 8 formed by a vanadium catalyst 7 loaded onto the partition wall surfaces 4a and/or the partition wall inner portions 4b of the partition walls 4. Furthermore, the honeycomb structure 6 has a circumferential wall 9 which covers a circumference of the partition walls 4.

The honeycomb structure 6 is formed by using a porous ceramic material. Therefore, the plurality of pores 5 are formed in the partition walls 4 as described above. Furthermore, the cells 3 of the honeycomb structure 6 extend along an axial direction X of the honeycomb catalytic body 1 (see FIG. 1), and when the fluid of an exhaust gas or the like flows in a direction from the one end face 2a, the cells 3 function as the through channels.

Here, the fluid which is passing through the cells 3 comes in contact with the catalyst layer 8 of the vanadium catalyst 7 loaded onto the partition wall surfaces 4a and/or the partition wall inner portions 4b of the partition walls 4. Therefore, NOₓ included in the fluid is purified, and emitted as a purified fluid from the other end face 2b. It is to be noted that FIG. 1 to FIG. 3 schematically show constitutions of the cells 3, the partition walls 4, the pores 5 and the catalyst layer 8, in sizes different from those of respective constitutions in the actual honeycomb catalytic body 1.

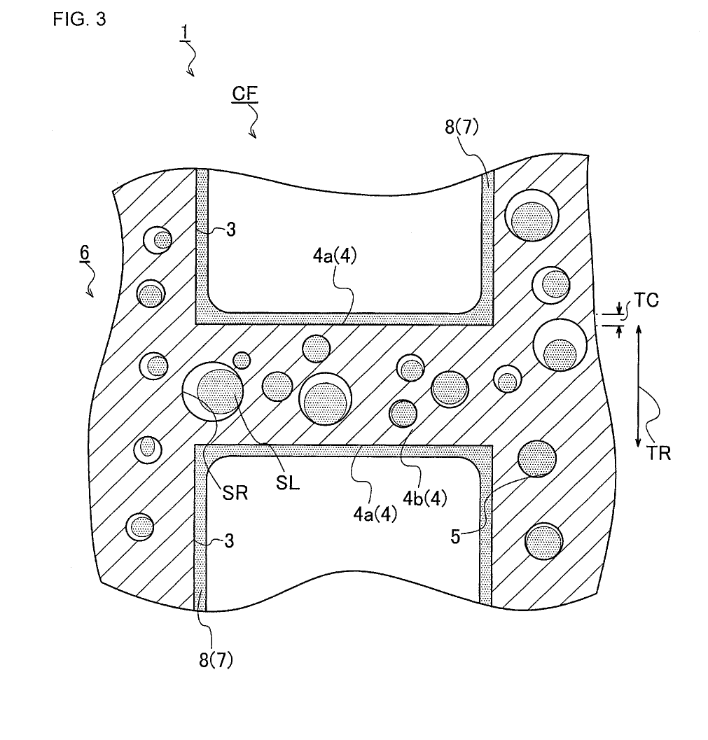

In the honeycomb catalytic body 1 of the present invention, a cell density of the honeycomb structure 6 is in a range of 8 cells to 48 cells per square centimeter. The honeycomb structure 6 in the above cell density range has a low cell density. Here, in the honeycomb structure 6 of the low cell density, an open sectional area CS (see a hatched region of FIG. 2) of the cells 3 is usually large, and hence, passage of the fluid through the cells 3 is less obstructed. Therefore, pressure loss of the fluid does not remarkably decrease between the one end face 2a and the other end face 2b.

When the cell density is lower than 8 cells/cm², a catalyst thickness increases, the catalyst coated on partition wall upper portions easily peels off, and hence, catalyst peel-off easily occurs. On the other hand, when the cell density is in excess of 48 cells/cm², there is the possibility that the pressure loss increases. Therefore, the honeycomb structure 6 in the above range of the cell density is employed as the honeycomb catalytic body 1 of the present invention in consideration of deterioration due to the catalyst peel-off and the pressure loss.

Furthermore, in the honeycomb catalytic body 1, an amount of the vanadium catalyst 7 to be loaded onto the partition walls 4 and to form the catalyst layer 8 (the amount of the catalyst to be loaded) is in a range of 150 g/L to 400 g/L and further preferably in a range of 150 g/L to 300 g/L.

Here, when the amount of the catalyst to be loaded increases, an amount of the catalyst which comes in contact with the fluid in the through channels of the cells 3 increases. Therefore, the honeycomb catalytic body having a large amount of the catalyst to be loaded has a high NOₓ purification ratio. The honeycomb catalytic body 1 of the present invention has the amount of the catalyst to be loaded which is larger than usual. Therefore, at least 150 g/L of the vanadium catalyst 7 needs to be loaded. However, when the vanadium catalyst 7 in excess of 400 g/L is loaded, close contact properties between the partition walls 4 and the catalyst layer 8 deteriorate, and the possibility of the occurrence of the catalyst peel-off heightens. Therefore, the honeycomb catalytic body 1 in the above range of the amount of the catalyst to be loaded is used. It is to be noted that the amount of the catalyst to be loaded is calculated on the basis of a difference between a weight before loading and a weight after loading which is obtained by measuring the weight and volume of the honeycomb structure 6 before the vanadium catalyst 7 is loaded and the weight of the honeycomb catalytic body 1 after the vanadium catalyst 7 is loaded.

Furthermore, in the honeycomb catalytic body 1 of the present invention, a catalyst filling ratio represented by Equation (1) mentioned below and indicating a ratio of a sectional area SL of the catalyst layer loaded onto the partition wall inner portions to a sectional area SR of the pores before the catalyst is loaded, in a cut face CF (FIG. 3) of a cut part of the honeycomb catalytic body 1 is set to a range of 50% to 100%.

the catalyst filling ratio (%)=(the sectional area SL of the catalyst layer loaded onto the partition wall inner portions)/(the sectional area SR of the pores before the catalyst is loaded)×100 Equation (1):

Here, the catalyst filling ratio indicates a ratio of the sectional area SL of the catalyst layer loaded onto the partition wall inner portions to the total area of the pores, when the sectional area SR of the pores before the catalyst is loaded is 100%, and such a range is set to the range of 50% to 100% in the honeycomb catalytic body 1 of the present invention. It is to be noted that FIG. 3 schematically shows the catalyst filling ratio, which is different from that of an actual catalyst layer.

When the catalyst filling ratio is lower than 50%, the vanadium catalyst 7 does not sufficiently penetrate to substrate inner portions of the partition wall inner portions 4b. Therefore, the catalyst layer 8 made of the vanadium catalyst 7 is formed only on the partition wall surfaces 4a, and hence, close contact properties between the partition walls 4 and the catalyst layer 8 deteriorate. Therefore, the catalyst peel-off easily occurs. To eliminate such a problem, a catalyst filling ratio of at least 50% is required.

Furthermore, the vanadium catalyst 7 may penetrate all over the pores in the partition walls (the catalyst filling ratio=100%). Here, the partition walls 4 of the honeycomb structure 6 are made of the porous ceramic material having the plurality of pores 5 as described above, and hence, the vanadium catalyst 7 can easily be penetrated and filled into the pores 5 of the partition wall inner portions 4b. It is to be noted that the filling of the vanadium catalyst 7 into the pores 5 is well known, and hence, detailed description is omitted here. Furthermore, a manufacturing method of the honeycomb structure 6 as a catalyst carrier onto which the vanadium catalyst 7 is loaded or the like is also well known, and hence, detailed description is omitted here.

Specifically, the vanadium catalyst can be filled into the partition wall inner portions 4b of the partition walls 4 by immersing the beforehand manufactured honeycomb structure 6 into a liquid containing the vanadium catalyst 7 adjusted in a predetermined viscosity, or by spraying the liquid to the partition walls 4, followed by drying or the like. It is to be noted that the vanadium catalyst 7 which is not filled into the partition wall inner portions 4b is laminated on the partition wall surfaces 4a. Here, there is formed the catalyst layer 8 in the honeycomb catalytic body 1 of the present invention including the vanadium catalyst 7 filled into the partition wall inner portions 4b and laminated on the partition wall surfaces 4a.

In an example of a technique of calculating the catalyst filling ratio, an SEM image (a scanning electron microscope image) in the cut face CF of the honeycomb catalytic body 1 is photographed and acquired, and the image is subjected to binarization processing by use of an existing image analysis technology, thereby obtaining the sectional area SL of the catalyst layer loaded onto the partition wall inner portions and the sectional area SR of the pores before the catalyst is loaded, in the SEM image, to calculate the ratio. The calculation of each of the sectional areas SL and SR based on such an image analysis technology is a well-known technology.

Furthermore, in the honeycomb catalytic body 1 of the present invention, a catalyst thickness TC of the catalyst layer 8 from each partition wall surface 4a is in a range of 0 μm to 30 μm.

When the catalyst thickness TC is in excess of 30 μm, the excessive catalyst layer 8 is formed on the partition wall surfaces 4a. As a result, a weight of the catalyst layer 8 itself increases, and the catalyst layer 8 easily falls from the partition walls 4. Therefore, the catalyst peel-off occurs. Therefore, the catalyst thickness TC is set to be not in excess of 30 μm. It is to be noted that when the catalyst thickness TC is 0 μm, it is indicated that the vanadium catalyst 7 is filled into the pores 5 of the partition wall inner portions 4b and that the catalyst layer 8 is formed in the partition wall inner portions 4b. Also in this case, when the catalyst comes in contact with the fluid, a NOₓ purifying performance can be exerted.

To calculation the catalyst thickness TC, the SEM image used during the calculation of the catalyst filling ratio is utilizable. That is, the thickness from a boundary between the partition walls 4 and the catalyst layer 8 laminated on the partition wall surfaces 4a (see FIG. 3) can be calculated by using the image analysis technology or the like.

In the honeycomb catalytic body 1 of the present invention, a porosity of the partition walls 4 may be in a range of 35% to 60% and an average pore diameter of the partition walls 4 may be in a range of 4 μm to 35 μm. The porosity and the average pore diameter noticeably contribute to the above-mentioned catalyst filling ratio. Therefore, when the porosity and the average pore diameter are adjusted in the above ranges, the honeycomb catalytic body 1 can be adjusted in a suitable catalyst filling ratio. Here, the porosity and average pore diameter of the partition walls 4 can be measured by the image analysis technology.

Furthermore, in the honeycomb catalytic body 1 of the present invention, a partition wall thickness TR of the partition walls 4 is in a range of 0.14 mm to 0.20 mm.

When the partition wall thickness TR is smaller than 0.14 mm, strength of the honeycomb structure 6 itself decreases, and hence, the honeycomb structure only has little practicality. On the other hand, when the partition wall thickness TR is in excess of 0.20 mm, pressure loss of a substrate itself heightens. Therefore, the partition wall thickness TR is set to the above range. It is to be noted that the partition wall thickness TR can be measured and calculated in the same manner as in the catalyst thickness TC.

As described above, in the honeycomb catalytic body 1 of the present invention, respective parameters of the cell density of the honeycomb structure 6, the amount of the catalyst to be loaded and the catalyst filling ratio are adjusted in prescribed ranges, respectively, so that it is possible to prevent the increase of the pressure loss, and there is little fear for the occurrence of the catalyst peel-off from the partition walls 4, while maintaining a large amount of the catalyst to be loaded. Furthermore, respective parameters of the catalyst thickness TC, the porosity and average pore diameter of the partition walls 4 and the partition wall thickness TR are also adjusted in suitable ranges, respectively, so that it is possible to obtain the honeycomb catalytic body 1 in which the above effect can more stably be acquired.

Hereinafter, description will be made as to examples of the honeycomb catalytic body of the present invention, but the honeycomb catalytic body of the present invention is not especially limited to these examples.

### Examples

(1) Preparation of Honeycomb Catalytic Body

A honeycomb structure was made of porous ceramics of cordierite, and formed by extrusion so that the honeycomb structure included partition walls which defined a plurality of cells possessing a quadrangular shape, and had a honeycomb diameter of 266.7 mm and a honeycomb length of 152.4 mm. Then, the honeycomb structure was immersed into a catalyst slurry containing a vanadium catalyst adjusted in a predetermined concentration, and then calcinated at a predetermined temperature, to prepare a honeycomb catalytic body. In obtained honeycomb catalytic bodies, honeycomb structures having different porosities, average pore diameters, cell densities, cell pitches and partition wall thicknesses were used, and immersion conditions on which each honeycomb structure was immersed into the catalyst slurry were varied to change an amount of the catalyst to be loaded, a catalyst filling ratio and a catalyst thickness after dried, respectively.

Further specifically, to increase the amount of the catalyst to be loaded more than in a conventional technology, the coating was performed twice, to change a conventional single coating layer to double coating layers. Furthermore, a catalyst immersion time necessary to immerse the honeycomb structure into the catalyst slurry was adjusted to be twice as much as a time in the conventional technology. The catalyst slurry for use was prepared by adding water and alumina sol at a rate of 25:1 to catalyst powder containing 75 mass % of TiO₂, 10 mass % of WO₃ and 2 mass % of V₂O₅ so that a catalyst concentration was 16 mass %. Furthermore, a coating treatment was performed under room temperature conditions. Additionally, in Examples 1 to 13, for the purpose of heightening catalyst filling properties, deaeration of the catalyst slurry was initially performed before the catalyst was coated, to take a countermeasure of preventing the catalyst filling ratio from being decreased due to bubbles generated in the catalyst slurry. Furthermore, during the coating of the catalyst, the catalyst was coated while evacuating the honeycomb structure, so that the catalyst was easy to enter pores.

Furthermore, concerning each of honeycomb structures of Examples 1 to 5, 8 and 10 to 12 and Comparative Example 5, to 100 mass % of cordierite forming raw material, 2.5 mass % of pore former, 60 mass % of dispersing medium, 5.6 mass % of organic binder and 30 mass % of dispersing agent were added, mixed and kneaded to prepare a kneaded material. As the cordierite forming raw material, alumina, aluminum hydroxide, kaolin, talc, and silica were used. Water was used as the dispersing medium, water absorbable polymer having an average particle diameter of 100 μm was used as the pore former, hydroxypropyl methylcellulose was used as the organic binder, and ethylene glycol was used as the dispersing agent. Additionally, as the water-absorbable polymer, there was used particulate polyacrylic ammonium salt in which a water absorptivity was from 15 to 25 times, and the average particle diameter was the above value (100 μm) after water was absorbed. On the other hand, 3.0 mass % of pore former was added to heighten porosity in Example 6, and 3.5 mass % of pore former was added in Examples 7, 9 and 13. Furthermore, in Comparative Examples 1 to 4 and 6, to decrease the porosity, 0 mass % of pore former was added. In this way, there were prepared 19 honeycomb catalytic bodies in a total of Examples 1 to 13 and Comparative Examples 1 to 6 having different parameters. Table 1 mentioned below shows a summary of values of the respective parameters.

TABLE 1

| | | | Average | Cell | Partition | Amount of | | |
|---|---|---|---|---|---|---|---|---|
| | | | pore | density | wall | catalyst to be | | Catalyst |
| | | | diameter/ | cells/ | thickness/ | loaded/ | Catalyst | thickness/ |
| | Cell shape | Porosity/% | um | cm² | mm | g/L | filling ratio/% | um |
| Example 1 | Quadrangular | 50 | 20 | 31 | 0.14 | 300 | 50 | 30 |
| Example 2 | Quadrangular | 50 | 20 | 24 | 0.14 | 300 | 50 | 30 |
| Example 3 | Quadrangular | 50 | 20 | 16 | 0.14 | 300 | 50 | 30 |
| Example 4 | Quadrangular | 50 | 20 | 16 | 0.18 | 300 | 50 | 30 |
| Example 5 | Quadrangular | 50 | 20 | 31 | 0.20 | 300 | 50 | 30 |
| Example 6 | Quadrangular | 55 | 35 | 31 | 0.20 | 300 | 55 | 20 |
| Example 7 | Quadrangular | 60 | 15 | 31 | 0.20 | 300 | 50 | 30 |
| Example 8 | Quadrangular | 50 | 20 | 31 | 0.14 | 180 | 50 | 30 |
| Example 9 | Quadrangular | 60 | 40 | 48 | 0.17 | 300 | 80 | 15 |
| Example 10 | Quadrangular | 50 | 20 | 31 | 0.14 | 400 | 50 | 30 |
| Example 11 | Quadrangular | 50 | 20 | 8 | 0.14 | 300 | 50 | 30 |
| Example 12 | Quadrangular | 50 | 20 | 31 | 0.23 | 300 | 50 | 30 |
| Example 13 | Quadrangular | 60 | 15 | 31 | 0.14 | 300 | 50 | 30 |
| Comparative | Quadrangular | 35 | 4 | 31 | 0.14 | 300 | 0 | 50 |
| Example 1 | | | | | | | | |
| Comparative | Quadrangular | 35 | 4 | 62 | 0.11 | 150 | 0 | 50 |
| Example 2 | | | | | | | | |
| Comparative | Quadrangular | 35 | 4 | 48 | 0.13 | 150 | 0 | 50 |
| Example 3 | | | | | | | | |
| Comparative | Quadrangular | 35 | 4 | 31 | 0.14 | 150 | 0 | 50 |
| Example 4 | | | | | | | | |
| Comparative | Quadrangular | 50 | 20 | 93 | 0.11 | 300 | 30 | 35 |
| Example 5 | | | | | | | | |
| Comparative | Quadrangular | 35 | 4 | 31 | 0.14 | 300 | 10 | 40 |
| Example 6 | | | | | | | | |

According to Table 1, in each of Examples 1 to 13, a parameter such as the porosity satisfies the above range prescribed in the honeycomb catalytic body of the present invention. On the other hand, in each of the honeycomb catalytic bodies of Comparative Examples 1 to 6, at least one of the respective parameters deviates from the above-prescribed range. For example, two parameters of a catalyst filling ratio and a catalyst thickness in Comparative Example 1 and four parameters of a cell density, a partition wall thickness, a catalyst filling ratio and a catalyst thickness in Comparative Example 2 deviate from the above-prescribed ranges (descriptions of the other comparative examples are omitted). In the respective prepared honeycomb catalytic bodies, values of NOₓ purification ratio and pressure loss were measured, and it was further confirmed whether or not catalyst peel-off occurred. General judgment of each honeycomb catalytic body was performed on the basis of the obtained values and confirmation results. Additionally, as described above, the honeycomb catalytic body of Comparative Example 2 in which four parameters deviated from the prescribed ranges was used as a comparison standard.

(Evaluation Item 1: Measurement of Catalyst Charging Ratio)

A filling ratio of the catalyst into pores of partition walls in the honeycomb catalytic body was measured by using two-dimensional image analysis software. Here, an area of 1.3 mm×1.0 mm was photographed in each of three regions of an inlet side, an outlet side and a center of a honeycomb central portion in a cross-section at right angles to a thickness direction of the partition walls, by use of a scanning electron microscope (SEM) (S-3400N manufactured by Hitachi, Ltd.), and a partition wall sectional portion of each of photographed images was analyzed by using the two-dimensional image analysis software (WinROOF manufactured by Mitani Corporation).

Furthermore, description is made as to details of the analysis. The images of the partition wall portions of the three regions on a partition wall surface as a boundary were binarized, color ratios of regions corresponding to voids, partition walls and vanadium which were different in light and shade were calculated, and catalyst filling ratios were measured on the basis of the ratios. Furthermore, an average value of the catalyst filling ratios of the respective regions (three regions) was obtained. In the above processing, when the luminance of the catalyst was close to that of a substrate and it was therefore difficult to perform the binarization, an area of the whole pore and an area of the pore filled with the catalyst were calculated on the image analysis software. In this case, the whole pore was manually selected by using a tool which was disposed in the image analysis software and with which an area of a manually selected portion was obtainable, and a ratio of respective calculated areas was obtained as the catalyst filling ratio (=a ratio of filled vanadium/a ratio of the pores of the partition walls).

(Evaluation Item 2: Measurement of NOₓ Purification Ratio)

A testing gas containing NOₓ was passed through each honeycomb catalytic body, and an amount of NOₓ in an exhaust gas emitted from the honeycomb catalytic body was further analyzed with a gas analyzer (MEXA9100EGR manufactured by HORIBA, Ltd.), thereby obtaining the value of the NOₓ purification ratio. Here, a gas temperature of the testing gas to flow into the honeycomb catalytic body was set at 200° C., and an infrared image furnace was used for preparation of the honeycomb catalytic body and the testing gas. As the testing gas, there was used a gas obtained by mixing nitrogen with 5 vol % of carbon dioxide, 14 vol % of oxygen, 350 ppm of carbon monoxide (a volume basis), 350 ppm of ammonia (a volume basis) and 10 vol % of water. Furthermore, a space velocity (SV) when the testing gas flowed into the honeycomb catalytic body was set to 4000 h⁻¹. The NOₓ purification ratio was measured on the basis of these testing conditions.

Further specifically, the NOₓ purification ratio in Table 2 is a value obtained by dividing, by an amount of NOₓ in the testing gas, a value obtained by subtracting an amount of NOₓ in the gas emitted from the honeycomb catalytic body from the amount of NOₓ in the testing gas, and then multiplying the obtained value by 100. Furthermore, in the judgment of the NOₓ purification ratio, when the NOₓ purification ratio was in excess of 25%, a judgment result was “excellent”, and when the ratio was 25% or less, the judgment result was “failure”.

(Evaluation Item 3: Measurement of Pressure Loss)

Air at 25° C. was passed through the honeycomb catalytic body placed under the room temperature conditions from one end face toward the other end face at a flow rate of 10 m³/min. At this time, a pressure of air in the one end face on an inflow side and a pressure of air in the other end face on an outflow side were measured, respectively, and a difference between the obtained pressure measured values was obtained as a value of pressure loss. In the judgment of the pressure loss, when a value of a difference in pressure loss was less than 0.36 kPa, a judgment result was “excellent”, and when the value was 0.36 kPa or more, the judgment result was “failure”.

(Evaluation Item 4: Confirmation of Presence/Absence of Catalyst Peel-Off)

Air at 25° C. and one atmosphere pressure was passed through the honeycomb catalytic body placed under the room temperature conditions from the one end face toward the other end face at a flow rate of 10 m³/min for 30 seconds. Carrier weights before and after the air was passed were confirmed, and at this time, when there was a weight change of 1 g or more before and after the air was passed, it was judged that catalyst peel-off occurred. Furthermore, presence/absence of “the catalyst peel-off” was also visually confirmed.

Table 2 mentioned below shows a summary of measurement results of the above three evaluation items, the confirmation result of the presence/absence of the catalyst peel-off, and the result of the general judgment. Furthermore, in the general judgment, when at least one of the three evaluation items was outside the prescribed range or the catalyst peel-off was “present”, the result of the general judgment was “failure”, and in the other cases, the result was “excellent”.

TABLE 2

| | NOx | | | |
|---|---|---|---|---|
| | purification | Pressure | Catalyst | |
| | ratio/% | loss/kPa | peel-off | Judgment |
| Example 1 | 50 | 0.2 | None | Excellent |
| Example 2 | 50 | 0.15 | None | Excellent |
| Example 3 | 50 | 0.09 | None | Excellent |
| Example 4 | 50 | 0.1 | None | Excellent |
| Example 5 | 50 | 0.25 | None | Excellent |
| Example 6 | 50 | 0.24 | None | Excellent |
| Example 7 | 50 | 0.24 | None | Excellent |
| Example 8 | 30 | 0.1 | None | Excellent |
| Example 9 | 50 | 0.35 | None | Excellent |
| Example 10 | 67 | 0.35 | None | Excellent |
| Example 11 | 50 | 0.06 | None | Excellent |
| Example 12 | 50 | 0.26 | None | Excellent |
| Example 13 | 50 | 0.18 | None | Excellent |
| Comparative Example 1 | 50 | 0.22 | Present | Failure |
| Comparative Example 2 | 25 | 0.23 | Present | Failure |
| Comparative Example 3 | 25 | 0.15 | Present | Failure |
| Comparative Example 4 | 25 | 0.11 | Present | Failure |
| Comparative Example 5 | 50 | 0.70 | None | Failure |
| Comparative Example 6 | 50 | 0.20 | Present | Failure |

As shown in Table 2, in the honeycomb catalytic bodies (Examples 1 to 13) which satisfy the parameter ranges prescribed in the present invention, it is recognized that a suitable result is obtainable in any evaluation item, and the result of the general judgment is “excellent”. That is, in the honeycomb catalytic body in which the cell density is from 8 cells per square centimeter to 48 cells per square centimeter, the amount of the catalyst to be loaded is from 150 g/L to 400 g/L and the catalyst filling ratio is from 50% to 100%, it has been confirmed that the catalyst peel-off does not occur, a large amount of the catalyst to be loaded is indicated, and a high NOₓ purification ratio can be maintained.

On the other hand, when at least one parameter deviates from the prescribed range as in Comparative Examples 1 to 6, the result of the judgment is “failure”. For example, it is confirmed that when the catalyst filling ratio is in a low range of 0% to 10% and the catalyst thickness is comparatively large in a range of 40 μm to 50 μm as in the honeycomb catalytic bodies of Comparative Examples 1 to 4 and Comparative Example 6, the catalyst peel-off mostly occurs. That is, it has been confirmed that when the vanadium catalyst does not sufficiently penetrate to the partition wall inner portions and the catalyst layer is thickly formed on the partition wall surfaces, close contact properties in the boundary between the partition wall surfaces and the catalyst layer are not sufficiently obtained and the catalyst peel-off easily occurs.

Furthermore, in the honeycomb catalytic body in which the cell density is in excess of 60 cells/cm² (Comparative Example 5), it has been confirmed that the pressure loss is remarkably 0.36 kPa or more. That is, in the case of the honeycomb catalytic body of the high cell density, the inflow of air or the like is obstructed due to the thickness of the catalyst layer formed on the partition wall surfaces. Additionally, as the cell density increases, needless to say, a value of the cell pitch also decreases.

In addition, when the partition wall thickness is less than 0.14 mm, the strength of the honeycomb catalytic body (or the honeycomb structure) itself deteriorates, damages due to impact and the like therefore easily occur, and it is difficult to practically use the honeycomb catalytic body. On the other hand, when the partition wall thickness is in excess of 0.20 mm, the pressure loss heightens.

A honeycomb catalytic body of the present invention is especially suitably utilizable as a part of a purifying treatment device for a purifying treatment of NOₓ included in an exhaust gas especially from a diesel engine.

### DESCRIPTION OF REFERENCE NUMERALS

1: honeycomb catalytic body, 2a: one end face, 2b: the other end face, 3: cell, 4: partition wall, 4a: partition wall surface, 4b: partition wall inner portion, 5: pore, 6: honeycomb structure, 7: vanadium catalyst, 8: catalyst layer, 9: circumferential wall, CF: cut face, CS: open sectional area, SL: sectional area of the catalyst layer loaded onto the partition wall inner portions, SR: sectional area of pores before the catalyst is loaded, TC: catalyst thickness, TR: partition wall thickness, and X: axial direction.

What is claimed is:

1. A honeycomb catalytic body comprising:
a honeycomb structure having porous partition walls which define a plurality of cells to form through channels for a fluid and in which a plurality of pores are formed, and
a catalyst layer including a vanadium catalyst loaded onto partition wall surfaces and/or partition wall inner portions of the partition walls,
wherein a cell density of the honeycomb structure is in a range of 8 cells to 48 cells per square centimeter,
an amount of the vanadium catalyst to be loaded is in a range of 150 g/L to 400 g/L, and
a catalyst charging ratio represented by Equation (1) mentioned below and indicating a ratio of a sectional area of the catalyst layer loaded onto the partition wall inner portions to a sectional area of the pores before the catalyst is loaded, in a cut face of the honeycomb catalytic body is from 50% to 100%.
the catalyst charging ratio (%)=(the sectional area of the catalyst layer loaded onto the partition wall inner portions)/(the sectional area of the pores before the catalyst is loaded)×100 Equation (1):

2. The honeycomb catalytic body according to claim 1,
wherein a catalyst thickness of the catalyst layer from the partition wall surfaces is in a range of 0 μm to 30 μm.

3. The honeycomb catalytic body according to claim 1,
wherein a porosity of the partition walls of the honeycomb structure is in a range of 35% to 60%.

4. The honeycomb catalytic body according to claim 1,
wherein an average pore diameter of the partition walls of the honeycomb structure is in a range of 4 μm to 35 μm.

5. The honeycomb catalytic body according to claim 1,
wherein a partition wall thickness of the partition walls of the honeycomb structure is in a range of 0.14 mm to 0.20 mm.
